(19) United States
(12) Patent Application Publication
(10) Pub. No.: US 2012/0200261 A1
(43) Pub. Date: Aug. 9, 2012

(54) System for Storing Electric Energy

(76) Inventor: Conrad Rossel, Syrgenstein (DE)

(21) Appl. No.: 13/390,481

(22) PCT Filed: Jul. 16, 2010
(86) PCT No.: PCT/EP10/04351

§ 371 Date: Apr. 25, 2012

(30) Foreign Application Priority Data
Aug. 27, 2009 (DE) 10 2009 039 159.2

(51) Int. Cl. H02J 7/00

(52) U.S. Cl. 320/118; 320/167; 320/166; 320/134

(57) ABSTRACT

A system for storing electrical energy is specified, comprising a plurality of storage cells having an operating voltage, wherein an electrical load and a switching element in series with the load are arranged parallel to the storage cell. The switching element being closed upon reaching or exceeding a threshold voltage. The system further comprises a control device, which is configured to influence the threshold voltage in response to a temperature.

The invention relates to a system for storing electrical energy according to the type defined in greater detail in the preamble of claim 1. In addition, the invention relates to a method for storing electrical energy.

Systems for storing electrical energy, and in particular here for storing electrical traction energy in electric vehicles or in particular in hybrid vehicles, are known from the general prior art. Typically, such systems for storing electrical energy are implemented using individual storage cells, which are electrically connected to one another in series and/or in parallel, for example.

Fundamentally, various types of accumulator cells or capacitors are conceivable as storage cells. Because of the comparatively high energy quantities and powers for the storage and removal of the energy for use in drivetrains for vehicles, and in particular for utility vehicles here, storage cells having a sufficient energy content and high power are preferably used as the storage cells. These can be accumulator cells in lithium-ion technology, for example, or in particular storage cells in the form of very high performance double-layer capacitors, however. These capacitors are generally also referred to as supercapacitors, super caps, or ultra-capacitors.

Independently of whether supercapacitors or accumulator cells having high energy content are used, in such constructions made of manifold storage cells, which are connected to one another in series as a whole or in blocks, the voltage of the individual storage cells is limited to an upper voltage value or a threshold value depending on the construction. If this upper voltage value is exceeded, for example, during charging of the system for storing electrical energy, the service life of the storage cell is generally drastically reduced.

Because of predetermined manufacturing tolerances, the individual storage cells typically slightly deviate from one another in their properties (for example, self-discharge) in practice. This has the result that individual storage cells have a somewhat lower voltage than the other storage cells in the system. Since the maximum voltage for the entire system generally remains equal, however, and this represents the typical activation criterion in particular during charging, it unavoidably occurs that other storage cells have a somewhat higher voltage and are charged beyond the permitted voltage limit during charging procedures. Such an overvoltage results, as already mentioned above, in a significant reduction of the possible service life of these individual storage cells and therefore of the system for storing electrical energy.

On the other hand, storage cells which are greatly reduced in their voltage can be reversed in polarity in cyclic operation in the system for storing electrical energy, which also drastically reduces the service life.

In order to counteract these problems, the general prior art essentially knows two different types of so-called cell voltage equalizers, which are each constructed as centralized or decentralized. In centralized electronics, all components are assembled into a control device, for example, while in the decentralized structure, on each one to two storage cells, the individual components are attached to a small circuit board especially for these one to two storage cells, for example. The generally typical terminology of the cell voltage equalization is slightly misleading here, since voltages or more precisely energies of the individual storage cells are not equalized with one another in this way, but rather the cells having high voltages are reduced in their excessively high voltages. Since the total voltage(s) of the system for storing electrical energy remain(s) constant, however, a cell which is reduced in its voltage by the so-called cell voltage equalization can be increased in its voltage again in the course of time, so that at least the danger of polarity reversal is reduced.

In addition to a passive cell voltage equalization, in which an electrical resistance is connected in parallel to each individual storage cell, and thus a continuous undesired discharge and also heating of the system for storing electrical energy occurs, an active cell voltage equalization is also used. An electronic threshold value switch is additionally connected in parallel to the storage cell and in series to the resistor. This construction, which is also referred to as bypass electronics, only permits a current to flow when the operating voltage of the cell is above a predetermined threshold voltage. As soon as the voltage of the individual storage cell falls back into a range below the predetermined threshold voltage, the switch is opened and current no longer flows. Because of the fact that the electrical resistor is always deactivated via the switch when the voltage of the individual storage cells is below the predetermined limiting value, an undesired discharge of the entire system for storing electrical energy can also be substantially avoided. A continuous undesired heat development is also not a problem in this solution approach to the active cell voltage equalization. However, actual equalization of the individual voltages of the cells among one another does not occur through the active cell voltage equalization, but rather upon exceeding the threshold voltage, the storage cell is discharged using a small bypass current, in order to limit the excess by a slow dissipation of the overvoltage. The bypass current only flows until the system for storing electrical energy is discharged again, since in this case the voltage falls below the corresponding voltage limit and the switch is opened again.

The service life of the system for storing electrical energy is of decisive significance in the case of hybrid drives, and in particular here in the case of hybrid drives for utility vehicles, for example, omnibuses in city or short-range traffic.

In contrast to typical drivetrains in the power class suitable for such applications, the system for storing electrical energy represents a substantial part of the costs for the hybrid drive. It is therefore particularly important that very long service lives are achieved in such applications.

In addition to the mentioned circumstance that the operating voltage of individual storage cells unintentionally exceeds a threshold voltage in the charge/discharge cycle, the operating temperature of the storage cell is a further parameter which decisively influences the service life. The service life of double-layer capacitors, for example, is strongly dependent on the operating temperature and the applied voltage. For example, during operation of a hybrid vehicle in a hot environment, low temperatures for the system for storing electrical energy cannot be ensured.

The operating temperature of a storage cell is also a function, in addition to the temperature of the environment in which the storage cell is located, of the profile of the charge/discharge cycles. This is relevant in particular in driving operation of vehicles which employ such a system for storing electrical energy using storage cells. During the recuperation of braking energy or, for example, during acceleration procedures (boosts), high energy quantities must be absorbed or discharged in a short time by the storage cells therein, for example. These charge/discharge cycles cause the release of waste heat, by which the storage cells are heated. In order not to achieve an excessively shortened service life in spite of these elevated temperatures, for this reason, the threshold voltage of the storage cells is selected as sufficiently low that excessive damage of the storage cells is substantially avoided even in the event of possibly occurring high operating temperatures.

The operation of storage cells at reduced operating voltage is accompanied by disadvantages, however. The usable energy content E of a capacitor storage cell is a function of the square of the operating voltage U of the storage cell:

W=1/2CU²

where

W: the energy content,

C: the capacitance, and

U: the operating voltage of the storage cell.

The energy content of a storage cell thus decreases disproportionately in the event of a reduced operating voltage. Furthermore, a reduced operating voltage additionally has the result that higher currents must flow to achieve the same power discharge or absorption. According to

Pᵥ=I²Rᵢ

where

Pᵥ: the loss power,

I: the current strength, and

Rᵢ: the internal resistance,

of the capacitor storage cell, a disproportionately higher loss power through current heat losses results from a higher current strength.

A reduced operating voltage of a capacitor storage cell or of an energy storage system based on such storage cells therefore increases the service life of the storage cells in that exceeding the threshold voltage is prevented up to an established higher temperature. However, this advantage is accompanied by the explained disadvantages of reduced total energy content and counterproductive increased lost heat production.

It is therefore an object of the invention to specify a system for storing electrical energy, which allows efficient energy storage and removal even at high operating temperatures and at least partially avoids the mentioned disadvantages.

This object is solved by a system and a method having the features of independent claims. Further embodiments of the invention are specified in the dependent claims.

In particular, the invention provides a system for storing electrical energy, comprising a plurality of storage cells having an operating voltage, wherein an electrical load and a switching element in series with the load are arranged parallel to the storage cell. The switching element is closed upon reaching or exceeding a threshold voltage. The system further comprises a control device, which is configured to influence the threshold voltage in response to a temperature.

It is therefore possible according to the invention to adapt the threshold voltage to a temperature using the control device. Thus, for example, the threshold voltage can be reduced in the case of a high temperature and increased in the case of low temperatures. The temperature can be an instantaneous temperature of a storage cell, a common temperature ascertained from multiple storage cells, a time-averaged average temperature value of one or more storage cells, or the instantaneously prevailing ambient temperature. A plurality of the mentioned temperature values can also be combined with one another or with other temperatures, for example, of components which are in direct or indirect thermal contact with the storage cells.

Using the temperature-coupled influence of the threshold voltage by the device, it is possible to reduce the threshold or maximum operating voltage at correspondingly high temperatures and thus allow operation which is advantageous for the service life of the storage cell. Simultaneously, it is possible that the control device provides a suitable higher threshold voltage value under operating conditions having lower temperature, which allows a better utilization of the energy storage capability of the storage cells. Overall, the energy storage system according to the invention allows an operation adapted to the instantaneously prevailing operating conditions. Instead of establishing a fixed low threshold voltage, which is possibly oriented to operating conditions which only occur rarely, and accepting increased waste heat, the solution according to the invention avoids a permanently reduced energy content and provides a flexible adaptation of the threshold voltage to a temperature. The mentioned disadvantages are thus avoided in normal operation.

In a preferred embodiment of the system according to the invention, it is provided that the control device is arranged at the storage cell. This arrangement results in short connection distances between the control device and the switching element.

In particular, it can be provided in this context that the switching element, the electrical load, and the control device for the storage cell are implemented as an independent electronic device arranged in the area of the storage cell. The control device can comprise the switching element and can particularly be implemented as a threshold value switch. Furthermore, a temperature sensor can also be provided as part of the electronic device or can be situated in direct proximity to the electronic device or the storage cell. Such an embodiment is particularly simple and cost-effective to implement.

Alternatively to this decentralized embodiment, in one embodiment of the invention, the control device is arranged remotely from the storage cell. This allows a greater freedom with respect to the constructions of the storage cell and the control device and therefore also an optimization thereof separately from one another.

The greater distance between storage cell and control device resulting through this embodiment can be overcome in that the control device is connected to the storage cell using a bus line. The bus line can transmit signals from the control device to the storage cell and/or in the reverse direction, for example. Possible signals transmitted via the bus are, for example, a signal for opening or closing the switching element, a temperature value of the storage cell, etc.

A particularly preferred embodiment of an energy storage system provides that a central control device is provided for a plurality of storage cells. For example, all storage cells can be grouped in blocks and controlled in blocks. However, it can also be provided that all storage cells are registered and controlled together as a single block. The total voltage of the storage cells is then registered as the operating voltage. In the central storage arrangement, multiple temperature values of various storage cells, for example, of one block, can be compared before influencing the threshold voltage, for example, and a more precise picture of the actually prevailing temperature can thus be obtained or plausibility checks of individual measured values can be performed. Furthermore, instead of or in addition to a registration of the temperature related to the storage cell, a temperature value related to the environment or two other system components can also be registered and incorporated in the control. The control device can be a separate component. However, it can also be provided that the control device is an integral component of a more comprehensive controller, for example, a drive controller. In addition, it can be provided that a central control device is combined with decentralized control devices or with temperature-related activatable switching elements, which are assigned to individual storage cells.

With respect to both described alternative embodiments of a centralized and decentralized arrangement of the control device, the control device can comprise a temperature sensor. In the decentralized arrangement of the control device in relation to the storage cells, this temperature sensor can be included in the control device and can register the storage cell temperature of one or two adjacent storage cells, for example. In the case of a centralized arrangement, the temperature sensor can additionally or alternatively register the ambient temperature or the other system components. However, it is also possible to provide decentralized temperature sensors in the centrally situated control device

The load of the system according to the invention can be a resistor. Alternatively, however, other means for dissipating electrical energy using oriented radiation are also conceivable, for example. The storage cell can be implemented as a so-called supercapacitor, i.e., as a double-layer capacitor.

In a simple embodiment, the switching element is a threshold switch. The threshold value of the threshold switch can then either be influenced in a decentralized manner using the control device situated on the storage cell or via the centrally situated control device via a signal bus or data bus. Optionally, the threshold switch, an associated temperature sensor, and the control device can form a common component or components separate from one another.

The activation of the switching element by a central control device can comprise a contactless transmission device, in particular an isolation amplifier. The isolation amplifier can be implemented by an optocoupler or an inductive coupling, for example, and can thus allow an activation of the switching elements which is electrically separated from the storage cells. Either the threshold voltage can be transmitted directly to the storage cell or an actuating signal for the switching element can be transmitted.

The above-mentioned object is also achieved by a system for storing electrical energy, which comprises a plurality of storage cells having an operating voltage, at least a number of storage cells being connected in series in such a manner that a system voltage results, and comprises a control device, which controls charging or discharging of the number of storage cells up to a threshold system voltage, the control device influencing the threshold system voltage in response to a temperature. The system is thus always charged up to a threshold system voltage according to the invention, which can be influenced as a function of temperature using the control device. It can be provided in particular that the threshold system voltage is reduced in the case of an elevated temperature and the threshold system voltage is increased in the case of a low temperature.

In a hybrid vehicle system, this influence or activation can be performed via the electric drive of the hybrid system, for example. For example, at a temperature of 10° C., 2.7 V per storage cell can be permitted, while only 2.4 V per storage cell are still permitted at a temperature of 35° C. The complete charge/discharge capacity of the energy storage system is thus utilized completely in the case of low temperatures or favorable cooling conditions and the desired service life is achieved, while in contrast excessive damage of the system does not occur at higher temperatures.

Such an influence of the threshold system voltage which combines all storage cells, however, neglects the fact that due to varyingly strongly discharged storage cells, others can be subjected to high individual storage cell operating voltages to achieve the system operating voltage, because of the series circuit, in particular at an elevated temperature. This circumstance can be taken into consideration by combination of this embodiment with the above-mentioned centralized influence of the threshold voltage and the decentralized influence with respect to the storage cells of the threshold voltage of an individual storage cell or a block of storage cells.

Furthermore, it can be provided in all above-mentioned embodiments that the control device comprises a time-switch device, which keeps the closed switching element closed for a predetermined time after closing. It is thus ensured that a storage cell, after it has exceeded the threshold voltage, is always automatically discharged for a predetermined time via the electrical consumer, such as a resistor, in the event of a closed switch. The voltage provided in this storage cell is thus dissipated over a longer period of time. This can have the result in particular that during the next charging cycle of the system for storing electrical energy, precisely this one storage cell does not again reach the upper limiting value of its operating voltage and does not have to be restricted in its voltage again via renewed closing of the switch. Rather, through the integration of a time function by a time-switch device, leveling of the voltage level of this storage cell occurs in particular in relation to the other storage cells. The storage cells reduced in their voltage are then also increased in their voltage again, so that in this way an actual cell voltage equalization in the literal meaning of the word occurs.

Therefore, also in the case of dynamic applications, for example, in a hybrid drive, in which a larger part of the electrical energy stored in the system is withdrawn by the starting, and energy is stored in the system again during the next deceleration, further exceeding of the upper threshold voltage of the affected storage cell is avoided with higher probability. Therefore, using very simple means, it is safely and reliably possible to prevent individual storage cells from reaching the range of the threshold voltage multiple times in sequence, which would massively impair their service life. Rather, through the construction of the system according to the invention, adaptation of the cell voltages of the individual storage cells among one another occurs very rapidly, so that many fewer storage cells reach the problematic range of the threshold voltage even in the case of highly dynamic charge and discharge cycles.

It can be provided that the switching element, the electrical load, the time-switch device, and optionally a temperature sensor are implemented as an independent electronic device situated in the area of the storage cell. Individual storage cells can thus be discharged in a targeted manner via the consumer for a predetermined time from a predetermined threshold voltage. This construction is comparatively simple and compact to construct. Via an integrated circuit and a suitable resistor, a corresponding construction can be implemented on a corresponding circuit board of very small dimensions for each individual storage cell, for example. This can then be situated in the area of the individual storage cell and functions completely independently.

Further advantageous embodiments of the system according to the invention and/or the method according to the invention further result from the exemplary embodiment, which is described in greater detail hereafter on the basis of the figures.

In the figures:

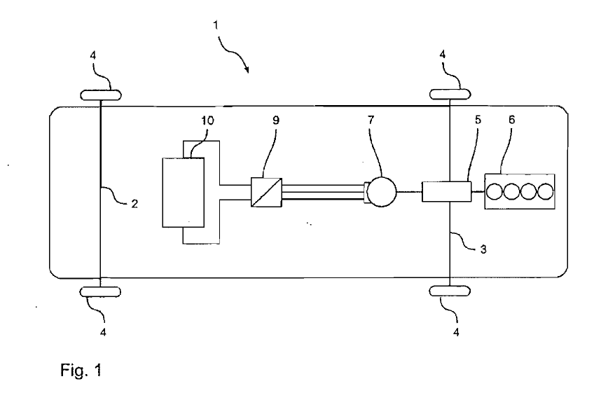

FIG. 1 shows an exemplary construction of a hybrid vehicle;

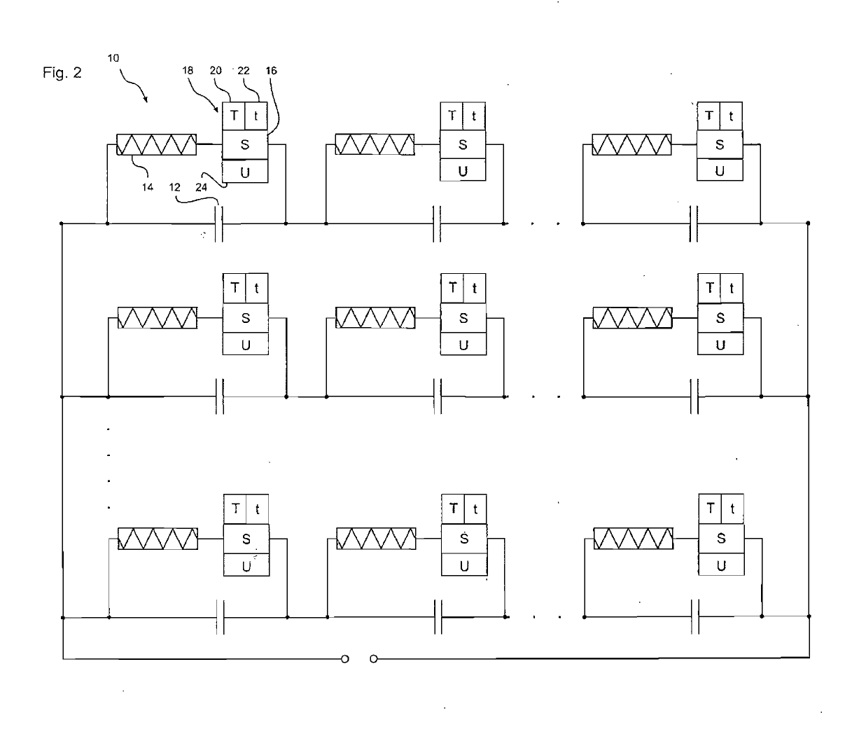

FIG. 2 shows a schematic illustration of a first decentralized embodiment of a system for storing electrical energy; and

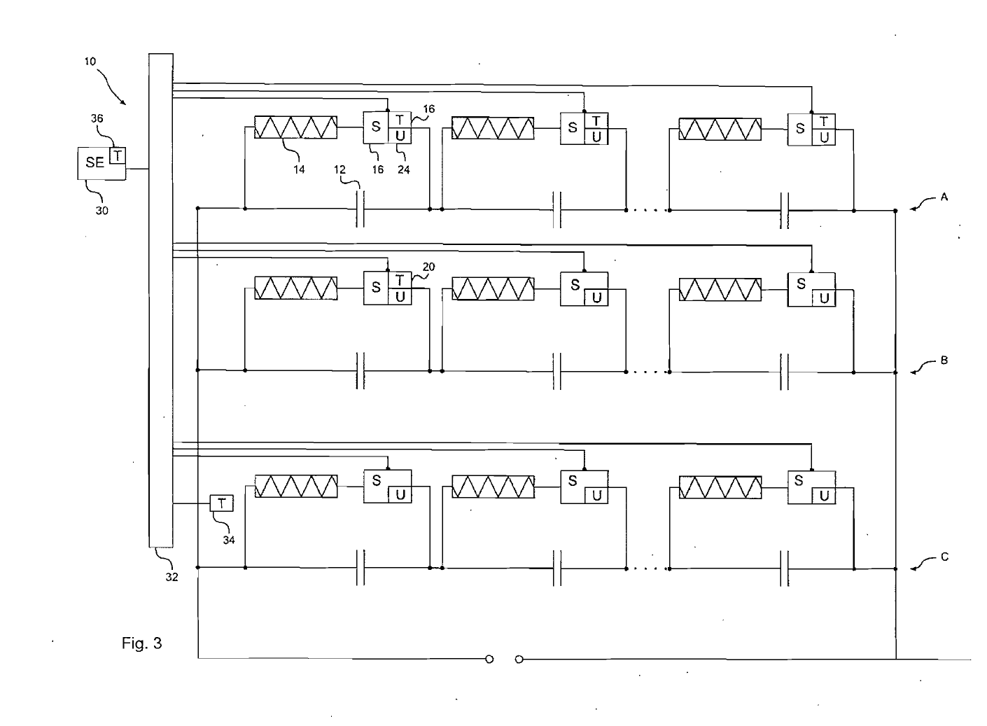

FIG. 3 shows a schematic view of a second centralized embodiment of a system for storing electrical energy.

An exemplary hybrid vehicle 1 is indicated in FIG. 1. It has two axles 2, 3, each having two exemplary indicated wheels 4. The axle 3 is to be a driven axle of the vehicle 1, while the axle 2 merely co-rotates in a way known per se. A transmission 5 is shown for driving the axle 3 as an example, which receives the power from an internal combustion engine 6 and an electrical machine 7 and conducts it into the area of the driven axle 3. In the drive case, the electrical machine 7 can, solely or additionally to the drive power of the internal combustion engine 6, conduct drive power into the area of the driven axle 3 and thus drive the vehicle 1 or support the drive of the vehicle 1. In addition, during deceleration of the vehicle 1, the electrical machine 7 can be operated as a generator, in order to thus reclaim power occurring during braking and store it accordingly. In order to also be able to provide a sufficient energy content in the case of use in a city bus as the vehicle 1 for braking procedures from higher velocities, which will certainly be at most approximately 70 km/h in a city bus, in this case a system 10 for storing electrical energy must be provided, which has an energy content in the magnitude of 350 to 700 Wh. Therefore, energies which arise during an approximately 10-second-long braking procedure from such a velocity can also be converted via the electrical machine 7, which will typically have a magnitude of approximately 150 kW, into electrical energy and stored in the system 10.

To activate the electrical machine 7 and to charge and discharge the system 10 for storing electrical energy, the construction according to FIG. 1 has an inverter 9, which is implemented in a way known per se having an integrated control device for the energy management. Via the inverter 9 having the integrated control device, the energy flow between the electrical machine 7 and the system 10 for storing the electrical energy is coordinated accordingly. The control device ensures that during braking, power arising in the area of the electrical machine 7, which is then operated as a generator, is stored as much is possible in the system 10 for storing the electrical energy, the voltage generally not being permitted to exceed a predetermined upper voltage limit of the system 10. In the drive case, the control device in the inverter 9 coordinates the withdrawal of electrical energy from the system 10, in order in this reverse case to drive the electrical machine 7 using this withdrawn power. In addition to the hybrid vehicle 1 described here, which can be a city bus, for example, a comparable construction would also be conceivable in a solely electric vehicle, of course.

FIG. 2 schematically shows a detail from a system 10 according to the invention for storing electrical energy in a first decentralized embodiment. Various types of the system 10 for storing electrical energy are fundamentally conceivable. Typically, such a system 10 is constructed so that a plurality of storage cells 12 are typically connected in series in the system 10. These storage cells 10 can be accumulator cells and/or supercapacitors, or also an arbitrary combination thereof. For the exemplary embodiment shown here, the storage cells 10 are all to be implemented as supercapacitors, i.e., as double-layer capacitors, which are to be used in a system 10 for storing electrical energy in the vehicle 1 equipped with the hybrid drive. The construction can preferably be used in a utility vehicle, for example, in an omnibus for city/short-range traffic. A particularly high efficiency of the storage of the electrical energy is achieved by the supercapacitors due to frequent starting and braking maneuvers in connection with a very high vehicle mass in this case, since comparatively high currents flow. Since supercapacitors as storage cells 12 have a very much lower internal resistance than accumulator cells, for example, they are preferred for the exemplary embodiment described in greater detail here.

As already mentioned, the storage cells 12 can be seen in FIG. 2. Only three storage cells 12 connected in series are shown. In the above-mentioned exemplary embodiment and at a corresponding electrical drive power of approximately 100 to 200 kW, for example, 120 kW, this would be a total of approximately 150 to 250 storage cells 12 in a realistic construction. If these are implemented as supercapacitors having a current upper voltage limit of approximately 2.7 V per supercapacitor and a capacitance of 3000 F, a realistic application for the hybrid drive of a city omnibus would be provided.

As shown in FIG. 2, each of the storage cells 12 has an electrical load, in the form of an ohmic resistor 14, connected in parallel to the respective storage cell 12. It is connected in series to a switching element 16, which is in parallel to each of the storage cells 12, in this case in parallel to each of the supercapacitors 12. The switch 16 is implemented as a threshold value switch and is part of a control device 18, which has the following functionalities: The control device 18 comprises a voltage monitor 24 of the supercapacitor 12. As soon as it exceeds an upper threshold voltage, the switch 16 is closed so that a current can flow out of the supercapacitor 12 via the resistor 14. The charge located therein and therefore also the voltage are reduced accordingly, so that further exceeding of the threshold voltage value in the same supercapacitor 12 as previously is avoided.

Furthermore, the control device 18 has a temperature sensor 20. It registers the temperature of the storage cell 12 directly or registers its immediate surroundings. It can also be provided in particular that a temperature sensor is used for two directly adjacent storage cells 12. The control device 18 converts the registered measured value of the temperature sensor 20 into a control of the threshold voltage value. In particular, the control device 18 regulates down the threshold voltage value when a higher voltage cell temperature exists and vice versa. Thus, for example, at a cell temperature of 10° C., the maximum permissible cell operating voltage, i.e., the threshold voltage of the cell, can be 2.7 V, while it is regulated to 2.4 V at 35° C. The systematic dependence between operating temperature of the storage cell 12 and its threshold voltage can be adopted in the form in which an assignment table is stored in the control device, which assigns a corresponding threshold voltage value for each temperature measured value. Intermediate values can be interpolated suitably if needed. However, a functional relationship can also be used to adapt the threshold voltage to the instantaneously prevailing storage cell temperature.

Alternatively, however, a regulation of the threshold voltage along a suitable regulated variable can also be provided.

In order to prevent the switch 16 from opening again as soon as the voltage drops below the threshold voltage value and therefore a very high voltage from remaining in the respective supercapacitor 12, a time-switch device 22 is additionally provided. In the case of switching solely via the voltage registration 24 of the switching device 18, the switch 16 would be opened again after the voltage falls below the threshold voltage. The supercapacitor 12 would then still be at a very high voltage level. If further charging of the system 10 occurs, precisely this supercapacitor 12 would then immediately be charged beyond the voltage limit again, which would then result in further closing of the switch 16. Through the integration of the time-switch function 22, which keeps the switch 16 closed for a predetermined time after it has been closed once via the voltage registration U, more charge is dissipated from the supercapacitor 12 than without the time-switch device 22. The voltage in the supercapacitor 12 is thus reduced enough that it does not again go beyond the upper limiting voltage after a discharge, for example, by starting of the vehicle 1 and renewed charging of the system 10 then occurring during braking. However, other supercapacitors 12 will now be in a correspondingly high voltage range and will in turn experience the above-described procedure. Overall, through the integration of the time-switch function 22, a rapid equalization of the voltages of the individual supercapacitors 12 of the system 10 therefore occurs over the operating time.

The time-switch device 22 can particularly be implemented so that a fixed time of several minutes is predetermined, for example. Together with the size of the respective individual storage cell 12 and the value of the electrical resistor 14, a corresponding discharge thus results. Discharges in the magnitude of 3-5% of the nominal charge of the corresponding supercapacitor 12 are advisable. Upon renewed charging, this supercapacitor 12 does not again exceed the predetermined limiting voltage. Because one of the supercapacitors 12 is at least prevented from exceeding the limiting voltage multiple times in very rapidly alternating sequence, a significant increase of the service life of the supercapacitors 12 and therefore of the system 10 is already achieved. In combination with the above-described control of the threshold voltage, a significantly increased service life of the system for storing electrical energy results overall.

If one uses the above-mentioned numeric example once again, with a dissipation current of 1 A, the voltage of the corresponding supercapacitor would have decreased by approximately 0.1 V in 5 min. With a dissipation current of 250 mA, this would accordingly take approximately 20 min. Depending on the size of the storage cell 12 and the possible dissipation current which can be conducted via the resistor 14, a time span of approximately 5 to 20 min. thus results, over which the switch 16 is held closed via the time-switch device 22. In the case of other orders of magnitude of the resistors, the currents, and the storage cells 12 used, this value can be adapted accordingly, of course. The system 10 thus constructed for storing electrical energy can also be used in the case of highly dynamic charge and discharge cycles, without the service life of the storage cells 12 being reduced accordingly by unnecessarily high voltages in the area of the storage elements 12.

In the present exemplary embodiment of FIG. 2, the construction of the control device 18, the electrical resistor 14, the switch 16, the temperature sensor 20, and the time-switch device 22 can be implemented as an integrated electronic device so that it is constructed independently for each individual one of the storage cells 12. For this purpose, in general a small integrated circuit is sufficient, which monitors the voltage U in the storage cell 12 accordingly and accordingly actuates the switch 16, which is implemented as integrated in the component as an electronic switch 16, for example. The resistor 14 can be placed on this mini circuit board in a way known per se. In the same way, the temperature sensor 22 can also be situated on this circuit board, if sufficient thermal coupling of the circuit board to the storage cell 12 is possible. Otherwise, a suitable supply line must be provided from the temperature sensor to the circuit board.

Since the time-switch device 22 typically always keeps the switch 16 closed for a predetermined time, after it has been activated because of the voltage of the storage cell 12, this time can also be fixedly integrated in the time-switch device 22 or the integrated electronic device. This can be implemented, for example, by programming a fixed predetermined time in an integrated circuit. It would also be conceivable to solve this by circuitry, in that this time is fixedly predetermined in the electronic device 14 via a suitable component, in particular a capacitor, at an output of the control device 18. The construction can thus be implemented very simply, since no activation of the electronic device from outside the system 10 is necessary. The system 10 will rather automatically ensure a cell voltage equalization, which also allows highly dynamic charge and discharge cycles. This construction having decentralized electronic devices is very simple and can be implemented completely autonomously. An activation of the system 10 is then only required as a whole, for example, during the discharging and in particular during the charging within a predetermined voltage window.

In addition to the described decentralized embodiment, alternatively or additionally, a temperature-dependent control of the total voltage of the storage cells can also be provided. It is provided that the maximum (total) voltage of the storage cells is varied as a function of a temperature. Thus, for example, in the case of temperatures below 10° C., 2.7 V per cell can be permitted as the individual cell operating voltage. With respect to the total number of storage cells connected in series, a specific maximum total voltage therefore results at this low ambient or storage cell temperature. At a temperature of 35° C., for example, only 2.4 V per cell are still permitted accordingly, so that a lower maximum total voltage of the system for storing electrical energy also results. The system for storing electrical energy is therefore still fully used and also achieves the desired service life in the case of low temperatures and/or favorable cooling conditions.

FIG. 3 shows a schematic view of a second centralized embodiment of a system 10 for storing electrical energy. Identical or comparable components are identified by identical reference numerals as in FIGS. 1 and 2. In contrast to the embodiment of FIG. 2, in this embodiment of the invention, the control of the threshold voltage of the individual storage cells 12 is not performed in a decentralized manner by individual control devices situated on the storage cells 12, but rather by a centrally situated control device 30. Such a centralized control device 20 can also be combined with decentralized control devices 10 situated on storage cells. It is connected to a bus 32, to which all storage cells 12 are in turn connected. Therefore, the individual storage cells 12 only have one switching element 16 and optionally one temperature sensor 20. The control device 30 can activate the switching elements 16 situated on the storage cells using the bus 32 and can therefore cause a discharge of the storage cells 12, if the threshold voltage is exceeded, via an electrical load 14, such as an ohmic resistor, connected in series with the switching element 16. Time-controlled tracking of the starting procedure as described in detail above can also be performed here. In the opposite transmission direction, the control device 30 receives the cell voltage which is instantaneously applied to the storage cell 12 and optionally temperature values.

The illustration of FIG. 3 is again solely schematic, in particular with respect to the number of storage cells 12. The numeric values occurring in a real embodiment were already stated above. To illustrate three different temperature registration scenarios, three blocks A, B, C are shown in FIG. 3, which are implemented differently with respect to their temperature registration and therefore also the corresponding activation.

The storage cells 12 combined in block A each have a temperature sensor 20. The temperature of each individual storage cell 12 is therefore registered and individual control, in relation to the storage cell, of the threshold operating temperature thus occurs.

In block B, only one storage cell 12 has a temperature sensor 20, solely as an example. However, it could also be provided that only a specific fraction of all storage cells 12 combined in block B are equipped with a temperature sensor. A block-related control of the threshold voltage on the basis of a temperature value registered with reference to a storage cell 12 is performed using the temperature value or values ascertained for the block B.

A block-related control of the threshold voltage is also provided for block C. In contrast to block C, the temperature value of a storage cell is not registered here, but rather the temperature value of a component, which is in direct or indirect thermal contact with one, multiple, or all storage cells 12, is registered using a temperature sensor 34. The component can be a shared cooling body or a housing component, for example.

The scenarios shown on the basis of blocks A, B, and C are each applicable alone for the entire system or in arbitrary combination. Furthermore, it can be provided that a central temperature-dependent control of the total voltage of the system for storing electrical energy can be performed via the electric drive of the hybrid system, for example. This system of influencing the total voltage as a function of the temperature and the further systems described as scenarios A, B, and C are additionally combinable with the decentralized solutions according to FIG. 2 as described above.

Furthermore, a temperature sensor 36 can additionally or solely be provided in the central control device 30. It can register the ambient temperature of the system 10 for storing electrical energy, for example. This can be an ambient temperature registered in the direct environment of the energy storage system 10 or also an ambient temperature of the vehicle 1 itself, for example.

1-18. (canceled)

19. A system for storing electrical energy, comprising multiple storage cells, which have an operating voltage, an electrical consumer and a switching element, which is in series with the consumer, being situated in parallel to a storage cell, and the switching element being closed upon reaching or exceeding a threshold voltage,
characterized in that the system comprises a control unit, which is configured for the purpose of influencing the threshold voltage as a function of a temperature, and
the switching element, the electrical consumer, and the control unit for the storage cell are implemented as an independent electronic unit situated in the area of the storage cell, so that a decentralized equalization of the operating voltages can occur.

20. The system according to claim 19, characterized in that the control unit comprises a temperature sensor.

21. The system according to claim 20, characterized in that the temperature sensor registers a temperature of the storage cell, or the temperature sensor registers an ambient temperature.

22. The system according to claim 19, characterized in that the consumer is a resistor and/or the storage cell is a supercapacitor.

23. The system according to claim 20, characterized in that the consumer is a resistor and/or the storage cell is a supercapacitor.

24. The system according to claim 21, characterized in that the consumer is a resistor and/or the storage cell is a supercapacitor.

25. The system according to claim 19, characterized in that the switching element is a threshold value switch.

26. The system according to claim 20, characterized in that the switching element is a threshold value switch.

27. The system according to claim 21, characterized in that the switching element is a threshold value switch.

28. The system according to claim 22, characterized in that the switching element is a threshold value switch.

29. The system according to claim 23, characterized in that the switching element is a threshold value switch.

30. The system according to claim 24, characterized in that the switching element is a threshold value switch.

31. The system according to claim 19, characterized in that the control unit comprises a time-switch unit, which keeps the closed switching element closed for a predefined time after closing.

32. The system according to claim 20, characterized in that the control unit comprises a time-switch unit, which keeps the closed switching element closed for a predefined time after closing.

33. The system according to claim 21, characterized in that the control unit comprises a time-switch unit, which keeps the closed switching element closed for a predefined time after closing.

34. The system according to claim 19, characterized in that the predefined time is fixedly predefined via a suitable component, in particular a capacitor.

35. The system according to claim 20, characterized in that the predefined time is fixedly predefined via a suitable component, in particular a capacitor.

36. The system according to claim 21, characterized in that the predefined time is fixedly predefined via a suitable component, in particular a capacitor.

37. The system according to claim 19, characterized in that all storage cells are implemented by the same type and are connected in series to one another.

38. The system according to claim 20, characterized in that all storage cells are implemented by the same type and are connected in series to one another.
